(19) United States
(12) Patent Application Publication
(10) Pub. No.: US 2004/0120525 A1
(43) Pub. Date: Jun. 24, 2004

(54) System and method for storage and retrieval of cryptographic keys

(76) Inventors: Robert Miskimmin, Toronto (CA); Trevor Bain, Toronto (CA); Kathirkamanathan (Nathan) Nadarajah, North York (CA); David Brown, Mississauga (CA); Cuong Thuy Luong, Woodbridge (CA); Steven Aitken, Toronto (CA)

Correspondence Address: KEATING & BENNETT LLP, Suite 312, 10400 Eaton Place, Fairfax, VA, 22030, US

(21) Appl. No.: 10/323,659

(22) Filed: Dec. 20, 2002

(51) Int. Cl. H04L 9/00

(52) U.S. Cl. 380/277

(57) ABSTRACT

A system and method for managing cryptographic keys on a recipient system. A key ring file is opened on the recipient system and at least a recipient private key of a cryptographic key pair associated with a particular entity is received. The recipient private key is saved in the key ring file such that the key is identifiably associated with the entity.

### FIELD OF THE INVENTION

The present invention relates to asymmetric encryption and more particularly to the storage and retrieval of cryptographic key pairs for use in asymmetric encryption.

### BACKGROUND OF THE INVENTION

Since its advent in the mid-twentieth century, the Internet (originally Arpanet) has provided an electronic information exchange alternative to posted mail, courier and, latterly, facsimile mail. The Internet was initially developed by the military as a distributed communication network designed to operate in the event one or more of the network nodes is rendered unserviceable by military attack. Since about 1990, the consistent efforts of software developers such as Microsoft, Netscape, etc. to provide user-friendly applications have facilitated penetration of the Internet into commercial and residential markets.

One area of intense research and development in the field of electronic information exchange such as provided by the Internet, is security of document transmission. The prior art is replete with examples of key based encryption/decryption systems, digital signature authentication systems, etc. The use of asymmetric key pairs, commonly referred to as public and private keys, is well known in the field of electronic information exchange security. Conventional methods include the generation of a public and private-key pair for a recipient, the public key being used in the encryption of a message and the private key being used by the recipient in the decryption of the message. Typically, the recipient installs cryptographic software, generates his or her own key pair and provides his or her public key to all other entities for secure electronic information delivery to the recipient while maintaining his or her corresponding private key as a secret. These are all possibly unfamiliar procedures that potentially discourage recipients from electing to receive secure electronic information delivery.

In some applications, where the entity delivering information to the recipient is more willing to generate and manage key pairs than the recipient, there are advantages to having the entity generate the key pair belonging to the recipient. The private key is then distributed to the recipient's system and is securely archived. The recipient's public key is made generally available.

There is no risk to the recipient if the entity is privy to the recipient's private key since the entity is securing and sending the electronic information to the recipient with the recipient's corresponding public key and the recipient's key pair is used for no other purpose.

It is anticipated that secure electronic information delivery to a single recipient will be sought by more than one entity, with the increasing use of the Internet for electronic information exchange. Thus, given that in many cases there is no trust relationship between different entities, a public and private-key pair is generated for the recipient by each entity. It will be appreciated that control and maintenance of the plurality of encryption keys that are consequently provided to the recipient, is desirable.

It is an object of an aspect of the present invention to provide a system and method for managing the storage and retrieval of cryptographic keys.

### SUMMARY OF THE INVENTION

In one aspect, there is provided a method for managing cryptographic keys on a recipient system. The method includes opening a key ring file on the recipient system, receiving at least a recipient private key of a cryptographic key pair associated with a particular entity, and saving the recipient private key in the key ring file so as to be identifiably associated with the particular entity.

In another aspect, there is provided a system for managing cryptographic keys on a recipient system. The system includes a key ring manager operable to open a key ring file on the recipient system, receive at least a recipient private key associated with a particular entity, and save recipient private key in the key ring file such that the recipient private key is identifiably associated with the particular entity.

Advantageously, a repository on the recipient system is transparently provided for storage and retrieval of keys. The recipient's key ring provides a highly secure repository for the recipient's multiple private keys, a repository for the recipient's corresponding multiple public-key certificates, and a repository for the entity's, herein after referred to as the enterprise, public-key certificates. The key ring provides a common, structured interface for the applications that have been designed to access it. Transparent management of the recipient's keys permits each of multiple enterprises to provide a private key and a public key to the recipient for use in secure electronic information delivery from each enterprise to the recipient. Thus, the recipient has multiple public and private keys, each public and private-key pair being provided by an enterprise in order for that enterprise to send secured electronic information to the recipient. A key ring manager is provided for the recipient system to locate the correct key associated with a particular enterprise with little recipient intervention.

### BRIEF DESCRIPTION OF THE DRAWINGS

The invention will be better understood with reference to the drawings and the following description in which;

FIG. 1 is a block diagram of a registration system;

FIG. 2 is a block diagram of the registration system of FIG. 1 after a key ring manager is sent to the recipient system;

FIG. 3 is a flow chart showing a process for registration with a registration authority according to an aspect of the present invention;

FIG. 4 is a flow chart showing a process for key storage in accordance with an aspect of an embodiment of the present invention; and

FIG. 5 is a flow chart showing the process for key retrieval in accordance with another aspect of the embodiment of FIG. 4.

### DETAILED DESCRIPTION OF THE PREFERRED EMBODIMENTS

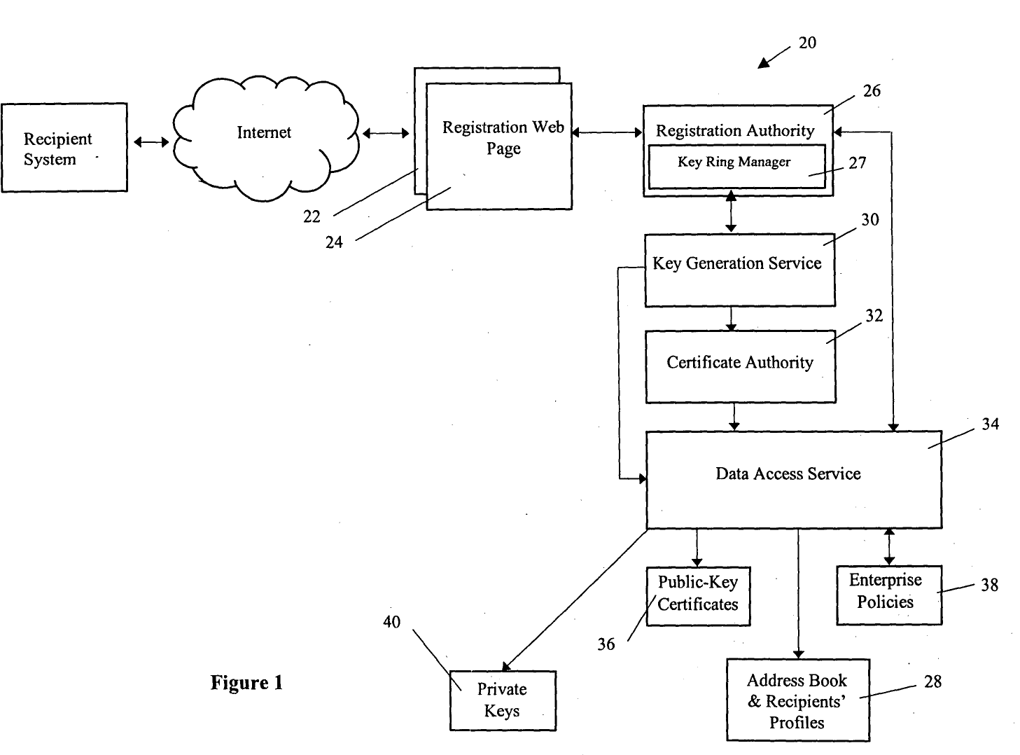

Reference is first made to FIG. 1, which shows a block diagram of a registration system, in accordance with applicant's own system for secure electronic information transmission, as described in applicant's co-pending U.S. patent application Ser. No. 10/147125, entitled System and Method for Secure Electronic Information Transmission, filed May 16, 2001, the contents of which are incorporated herein by reference.

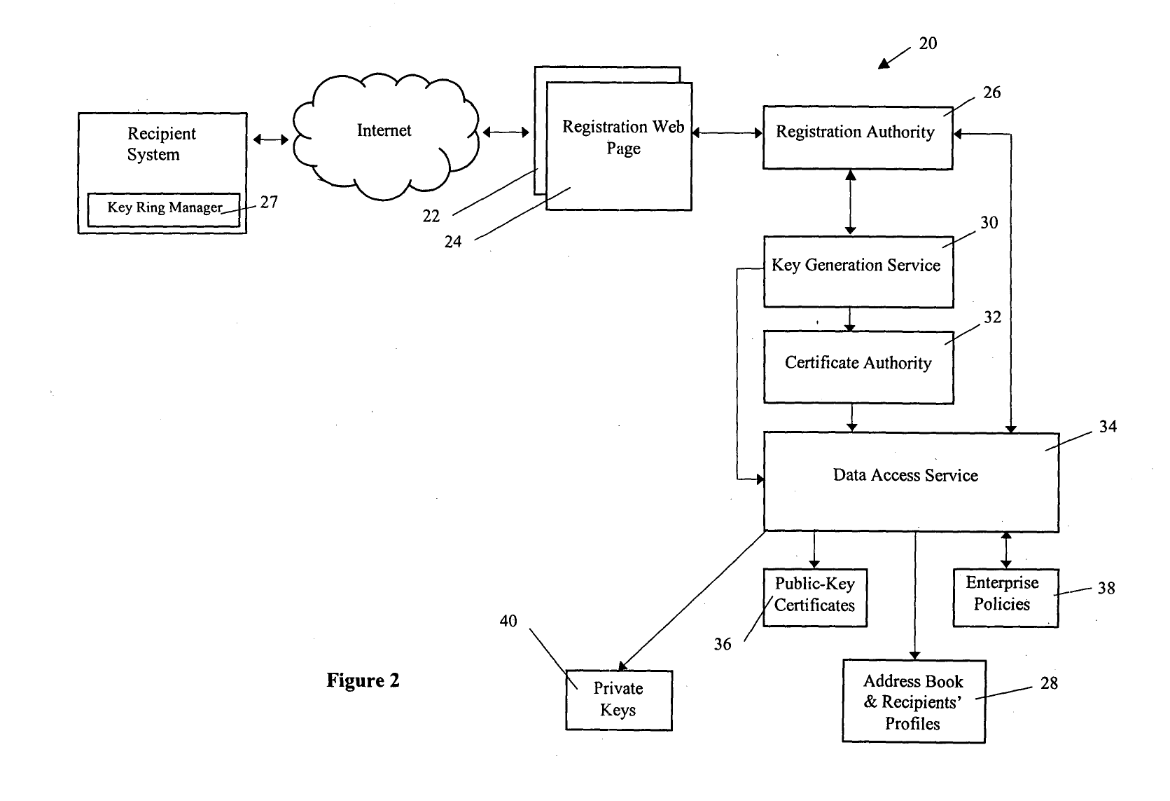

The registration system, indicated generally by the numeral 20, includes a web service (not shown) that supports a local web site 22 on the world-wide web and a registration web page 24 at the local web site 22. The registration authority 26 is a processing application that provides an interface for the registration of a new recipient through the registration web page 24. The registration authority 26 provides the function calls for collection of a recipient's contact information and personal preferences, which are stored in an address book and recipient profile database 28. The registration authority 26 also provides a key ring manager 27 to the recipient's system, as shown in FIG. 2. The key ring manager 27 is an applet that runs on the recipient's system.

The registration authority 26 is connected to a key generation service 30 for generating public and private encryption keys in the registration system. A certificate authority 32 receives the public key, generates a public-key certificate and signs the public-key certificate, binding the recipient's identification to the public key.

The key ring manager 27 on the recipient's system retrieves the private key and provides secure, transparent download and storage of the recipient's private key through the registration web page 24.

A data access service 34 provides transparent and secure access to various data sources. The data access service 34 maintains a database of the public-key certificates 36, which include the public keys generated for the recipient. Such public keys are used in secure delivery of an encrypted electronic document to the recipient. An example of a suitable data access service is an X.500 directory service. The data access 34 also maintains the address book and recipients' profile database 28 including the contact information of the recipient and the recipient preferences. These preferences include, for example, the manner in which each recipient prefers to receive electronic documents and other personal messages, such as receiving messages on a personal computer including attachments, on a personal digital assistant (PDA) without attachments or posting to a secure personal web page. This address book and recipient's profile database 28 is shared with a complementary secure electronic document delivery system, such as that described in applicant's own U.S. patent application Ser. No. 10/147,125, entitled “System and Method for Secure Electronic Information Transmission”.

An enterprise policies database 38 is also provided for storing the data associated with the security and operational policies related to the delivery of electronic documents. For example, data relating to the roles and privileges for administration and management of the registration and electronic document delivery systems, is stored.

A private-key database 40 is provided for secure archival of the recipient's private key, using known secure methods.

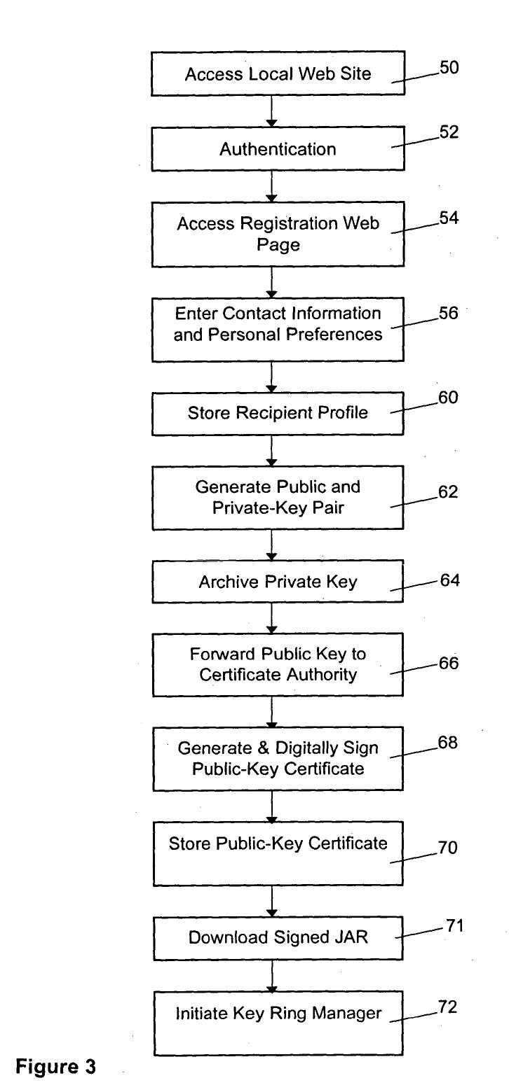

Reference is now made to FIG. 3 to describe the process steps for registration with a registration authority. In order to receive secure electronic documents, the recipient accesses the local web site 22 (step 50) via the Internet, using the recipient's web browser. Prior to registration, the local web site 22 authenticates the recipient based on, for example, a shared secret such as a web log-on identification and password, a personal identification number, a passphrase, or a certificate exchange if the browser is SSL enabled (Secure Sockets Layer protocol) with client side authentication (step 52). After successful authentication, the recipient then accesses the registration web page 24 via secure HTTPS connection from a web browser (step 54) and is prompted to enter information such as the recipient's contact information, e-mail address and personal preferences (step 56). The information entered by the recipient is stored in the address book and recipients' profiles database 28 (step 60).

The key generation service 30 generates a public and private-key pair for the recipient (step 62). The private key is archived in the private-key database 40 (step 64) and the public key is forwarded to the certificate authority 32 as part of a digital certificate request (step 66). The certificate authority 32 generates a digital public-key certificate, which includes the recipient's identification information and public encryption key, digitally signs the public-key certificate (step 68), and stores the public-key certificate in the public-key certificates database 36 (step 70).

The registration authority downloads a signed Java archive (JAR) file, which includes the key ring manager 27, to the recipient's system (step 71). The key ring manager 27 is a collection of Java objects on the recipient system and is responsible for key storage, key retrieval and general management of all key ring files.

The registration authority initiates the key ring manager 27 (step 72), thereby starting the key retrieval and storage process.

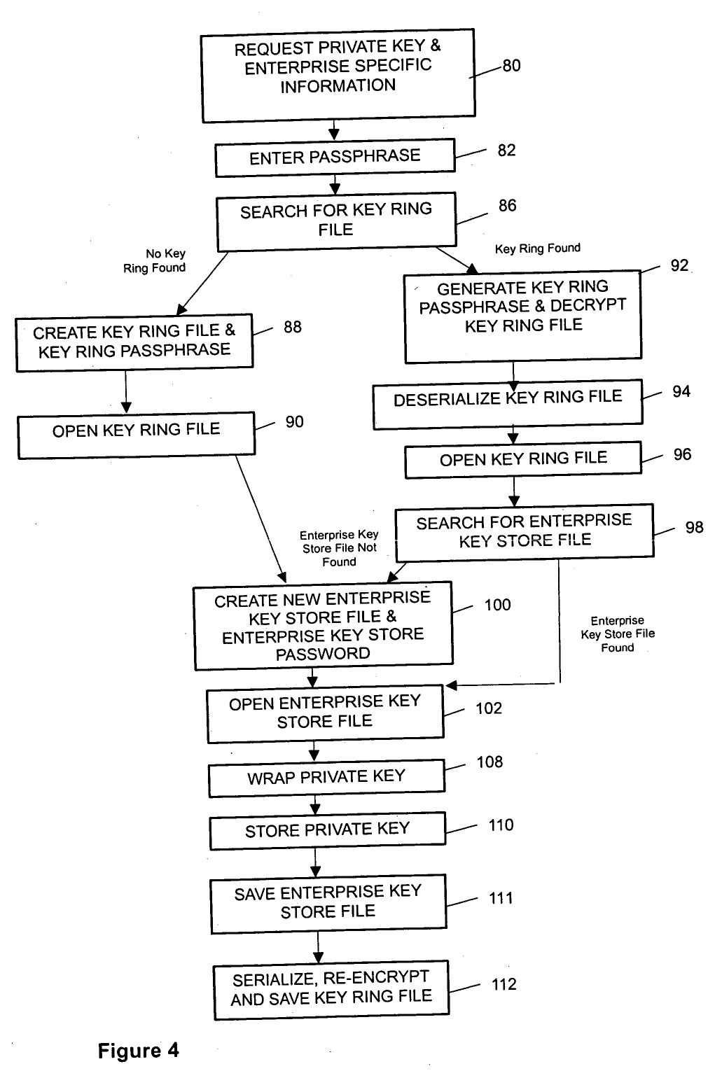

Reference is now made to FIG. 4 to describe an aspect of a preferred embodiment of the system and method for storage and retrieval of cryptographic keys. FIG. 4 is a flow chart showing a process for key storage, in accordance with an aspect of an embodiment of the present invention. In the present embodiment, the recipient system is a personal computer connected to the Internet.

The key ring manager 27 securely connects to the registration authority 26 to request and retrieve the private key, as well as enterprise specific information including an enterprise identifier, which is a unique identifier that is specific to the enterprise (step 80). The key ring manager 27 utilizes the enterprise specific information in creating and managing a key ring file. The key ring manager 27 prompts the recipient to enter a recipient personal passphrase (step 82). This passphrase is a new personal passphrase for cryptographically wrapping the private key.

The key ring manager 27 searches for the key ring file on the recipient system (step 86). The key ring file is an information file for all of the individual enterprises' key ring sub-files, referred to herein as enterprise key store files, and associated enterprise key store passwords. If the key ring file does not exist, the key ring manager 27 creates a new key ring file and associated key ring passphrase by performing a string concatenation of information specific to the recipient's device (step 88). The new key ring file is opened (step 90) and a new, empty enterprise key store file is created (step 100), using Java Crypto API function calls. The enterprise key store file is labeled with the enterprise identifier. An associated enterprise key store password is also constructed for the enterprise key store file by performing a string concatenation of the enterprise specific information.

If the key ring exists, it is stored in serialized and encrypted form. The key ring manager 27 re-constructs the key ring passphrase and decrypts the serialized key ring file using this key ring passphrase (step 92). The key ring file is then de-serialized into a Java object which is readable using Java API (Application Programmer's Interface) (step 94). The key ring manager 27 opens the key ring file (step 96) and, using the enterprise specific information, searches for an enterprise key store file associated with the enterprise with which the recipient is registering (step 98). If the enterprise key store file is not found, then a new key store file associated with the enterprise is created on the recipient system. The enterprise key store file is labeled with the enterprise identifier. An associated enterprise key store password is also constructed for the enterprise key store file by performing a string concatenation of the enterprise specific information (step 100).

After creation of the new enterprise key store file, or if an enterprise key store file is found at step 98, the enterprise key store file is opened with the previously constructed enterprise key store password using Java Crypto API function calls (step 102).

Next, the private key is cryptographically wrapped by the key ring manager 27 (step 108) using the recipient personal passphrase and the wrapped private key is stored in the enterprise key store file corresponding to the enterprise (step 110). The wrapped private key is labeled with a unique identifier that is specific to the recipient, referred to herein as the recipient identifier.

The enterprise key store file is saved and closed (step 111). The key ring file is then serialized, re-encrypted and saved (112). In the present embodiment, the key ring Java object is converted to a key ring file using Java API function calls, serialized, encrypted into non-readable characters and saved.

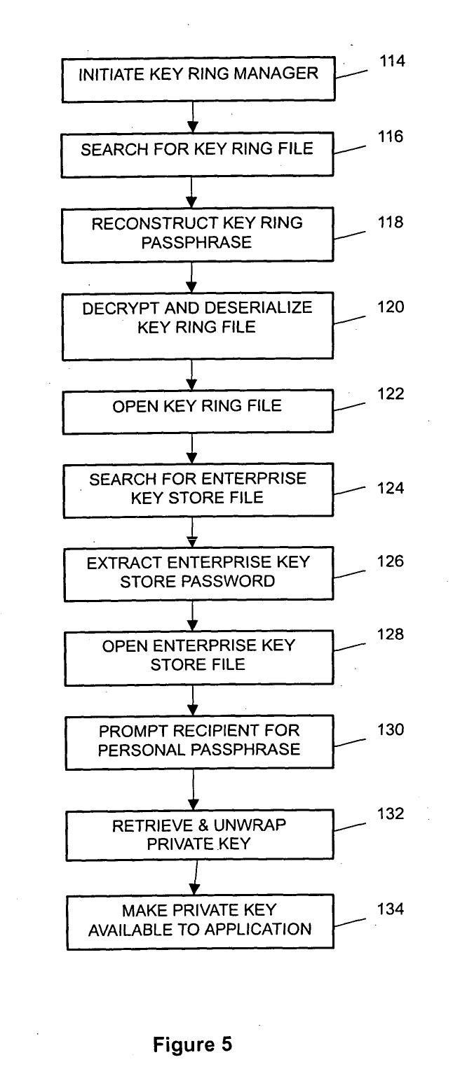

Referring to FIG. 5, the private-key retrieval process is described. An application initiates the key ring manager 27 (step 114). The key ring manager 27 retrieves information necessary for accessing the key ring file, including the enterprise specific information and the recipient identifier, from the application. Using this information, the key ring manager 27 performs several operations. The key ring manager 27 searches for the key ring file (step 116) and re-constructs the key ring passphrase (step 118). The key ring file is decrypted, de-serialized (step 120) and then opened (step 122). Next, the key ring manager 27 searches for the enterprise key store file corresponding to the enterprise identifier, included in the enterprise specific information (step 124), and extracts the corresponding enterprise key store password (step 126). The key ring manager 27 opens the enterprise key store file using the enterprise key store password (step 128).

Next, the recipient is prompted for the recipient personal passphrase (step 130). This is the passphrase that was selected at step 82 for wrapping the private key issued by the enterprise. The key ring manager 27 retrieves the recipient private key associated with the enterprise from the enterprise key store file using the recipient identifier and unwraps the private key (step 132). The key ring manager 27 makes the unwrapped private key available for use by the application (step 134).

In one example, the recipient receives an electronic mail (e-mail) message with an HTML attachment. Embedded within this attachment is a digitally-signed, base 64 encoded JAR file. The JAR file contains the enterprise specific information (including the enterprise identifier), the recipient identifier, and a viewer applet. Alternatively, the viewer applet is already stored on the recipient system.

The e-mail is sent using a secure delivery system such as that described in applicant's own U.S. patent application Ser. No. 10/147,125, entitled “System and Method for Secure Electronic Information Transmission”. When the e-mail is opened, the key ring manager 27 is initiated (step 114). The key ring manager 27 searches for the key ring file (step 116), re-constructs the key ring passphrase (step 118), and then decrypts, de-serializes (step 120), and opens the key ring file (step 122).

The key ring manager 27 searches within the key ring file for the enterprise key store file, associated with the enterprise that sent the e-mail (step 124). The associated enterprise key store password is extracted from the key ring file (step 126) and the enterprise key store file is opened using the enterprise key store password (step 128).

The key ring manager 27 prompts the recipient for the recipient personal passphrase (step 130). The recipient's private key associated with the enterprise is then located from within the enterprise key store file, and unwrapped (step 132) using the recipient personal passphrase. The recipient's private key is used to unwrap the symmetric encryption that was used to encrypt the e-mail (step 134).

Alternative embodiments and variations of the invention are possible. In one embodiment, the key ring file includes more than one key ring sub-file, each key ring sub-file, or enterprise key store file, being associated with an individual enterprise. Further, each enterprise key store file can include more than one wrapped private key associated with a single enterprise, each private key being associated with respective individual recipients. This is especially useful where a single recipient system is shared by more than one recipient. The key ring file can also include public keys that are stored and retrieved in a similar manner to the above-described storage and retrieval of the private key. It is also contemplated that if a recipient wishes to retrieve or replace a private key from the enterprise, the recipient can access the registration system and request this service. Also, the recipient system can be a personal digital assistant or other intelligent device. It is also contemplated that further security steps can be taken, in addition to what has been described, for example, the private key can be further secured as it is being downloaded to the recipient. Other variations and modifications may occur to those of skill in the art, all of which are believed to be within the sphere and scope of the present invention.

What is claimed is:

1. A method for managing cryptographic keys on a recipient system, comprising:
opening a key ring file on the recipient system;
receiving at least a recipient private key of a cryptographic key pair associated with a particular entity; and
saving said recipient private key in said key ring file, so as to be identifiably associated with said particular entity.

2. The method for managing cryptographic keys according to claim 1, further comprising creating said key ring file on said recipient system prior to opening said key ring file.

3. The method for managing cryptographic keys according to claim 1, wherein said step of saving said recipient private key comprises opening an enterprise sub-file in said key ring file and saving said recipient private key in said enterprise sub-file.

4. The method for managing cryptographic keys according to claim 3, further comprising creating said enterprise sub-file in said key ring file prior to opening said enterprise sub-file.

5. The method for managing cryptographic keys according to claim 1, wherein said saving said recipient private key comprises saving said recipient private key so as to be identifiably associated with a particular recipient in addition to being identifiably associated with said particular entity.

6. The method for managing cryptographic keys according to claim 1, further comprising receiving a public key of said cryptographic key pair associated with said particular entity and saving said public key in said key ring file so as to be identifiably associated with said particular entity.

7. The method for managing cryptographic keys according to claim 1, further comprising receiving an enterprise public key associated with said particular entity and saving said enterprise public key in said key ring file so as to be identifiably associated with said particular entity.

8. The method for managing cryptographic keys according to claim 6, wherein said public key is received in a public-key certificate.

9. The method for managing cryptographic keys according to claim 7, wherein said enterprise public key is received in a public-key certificate.

10. The method for managing cryptographic keys according to claim 1, further comprising cryptographically wrapping said recipient private key prior to saving said recipient private key.

11. The method for managing cryptographic keys according to claim 1, further comprising: serializing said key ring file; and saving said key ring file.

12. The method for managing cryptographic keys according to claim 1, further comprising: opening said key ring file;
identifying said recipient private key associated with said particular entity;
retrieving said recipient private key; and
providing said recipient private key to an application for decrypting information received from said particular entity.

13. A system for managing cryptographic keys on a recipient system, comprising a key ring manager operable to open a key ring file on the recipient system, receive at least a recipient private key associated with a particular entity, and save at least said recipient private key in said key ring file such that said recipient private key is identifiably associated with said particular entity.

14. The system for managing cryptographic keys according to claim 13, wherein said key ring manager is further operable to create said key ring file on said recipient system.

15. The system for managing cryptographic keys according to claim 13, wherein said key ring manager is further operable to open an enterprise sub-file in said key ring file and save said recipient private key in said enterprise sub-file.
